(19) United States
(12) Patent Application Publication
(10) Pub. No.: US 2002/0001002 A1
(43) Pub. Date: Jan. 3, 2002

(54) CONFIGURABLE PRINTHEAD APPARATUS AND METHOD

(75) Inventors: DARYL E. ANDERSON, CORVALLIS, OR (US); JEFFERY S. BECK, CORVALLIS, OR (US); DENNIS J. SCHLOEMAN, CORVALLIS, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Company

(21) Appl. No.: 09/300,792

(22) Filed: Apr. 27, 1999

(51) Int. Cl. B41J 2/01

(52) U.S. Cl. 347/9

(57) ABSTRACT

A configurable printhead that includes a plurality of potential signal inputs. The printhead preferably contains logic that is responsive to a signal from a printer controller or elsewhere that specifies the number potential signal inputs that are going to be used for signal (data) transmission. Configurability of the input lines and clock speeds permits use of the printhead in a range of printer environments and may serve to reduce EMI. Printer arrangements and a processing method are also disclosed.

### FIELD OF THE INVENTION

The present invention relates to printers and printerheads and, more specifically, to configurable printer and printhead arrangements.

### BACKGROUND OF THE INVENTION

Many types of printers are known and they include ink jet, laser and various thermal and impact printers. Ink jet printers include those that are thermally actuated (e.g., resistive element) and those that are mechanically actuated (e.g., piezo-electric element). Representative ink jet printers include those made by Hewlett Packard, Canon and Epson, etc. The present invention is applicable to all printers and particularly to ink jet printers.

In a representative prior art ink jet printer, control logic and other components propagate signals to a printhead. These signals typically include a clock signal, power, print data and configuration information, etc. The printhead is typically mounted on a moveable carriage and the signals are delivered by a flexible cable or the like.

The number of signal lines, the speed of data transmission and the type of signal conductors, amongst other design features, may vary depending on the intended use of the printer. For example, in an environment where EMI is not of particular concern (e.g., slow clock rates, etc.) and/or there are plenty of available connecting leads, a ribbon cable may be used to connect to the printhead. When EMI is of concern, then more expensive co-axial leads or the like may be utilized. Furthermore, when connecting lead availability is limited, then a high speed serial conductor may be utilized as opposed to multiple lower speed conductors.

Thus, conventional printheads are designed to have a specific configuration that naturally corresponds to their intended purpose. These printheads cannot readily be used in other printing devices, however, that perform a different function or operate in a different environment. A new printhead must be designed and built for the new function or environment.

A need thus exists for a printhead that is configurable for use in a range of printer environments/configurations. A need also exists for a printhead that is configurable so as to reduce EMI.

### SUMMARY OF THE INVENTION

Accordingly, it is an object of the present invention to provide a printhead in which signal lines coupling to the printhead may be configured into a desired format.

It is another object of the present invention to provide a printhead that permits a user to select parameters such as transfer rate and number of transmission lines so as to reduce EMI.

It is also an object of the present invention to provide a printer that incorporates and/or facilitates use of such a printhead.

These and related objects of the present invention are achieved by use of a configurable printhead apparatus and method as described herein.

The attainment of the foregoing and related advantages and features of the invention should be more readily apparent to those skilled in the art, after review of the following more detailed description of the invention taken together with the drawings.

### BRIEF DESCRIPTION OF THE DRAWINGS

FIG. 1 is a schematic diagram of a printer and printhead in accordance with the present invention.

FIG. 2 is a cross-sectional view of a representative firing chamber for use in the printhead of FIG. 1 in accordance with the present invention.

FIG. 3 is a schematic diagram of demultiplexing and configuration logic in accordance with the present invention.

### DETAILED DESCRIPTION

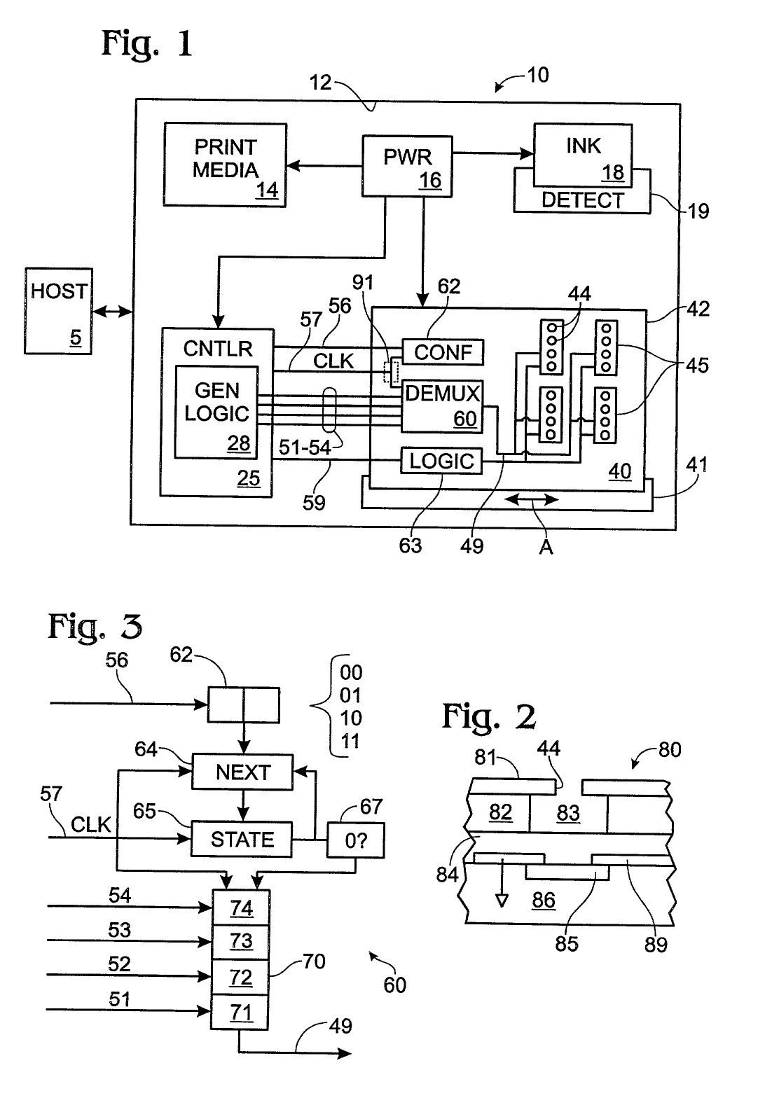

Referring to FIG. 1, a schematic diagram of a printer and printhead in accordance with the present invention is shown. Printer 10 preferably includes a housing 12 in which are provided print media input/output (I/O) unit 14, a power supply 16, an ink supply 18, controller logic 25 and a printhead 40, amongst other related components. The print media I/O unit preferably includes paper input and output trays, guides, and appropriate sensors and transport mechanisms, etc. Power supply 16 provides regulated DC at appropriate voltage levels.

Ink supply 18 may be formed integrally with printhead 10 or formed separately. Ink supply 18 may be provided in a refillable or replaceable manner. Ink level detection logic 19 is preferably provided with ink supply 18 to indicate an ink volume level. Suitable ink supply arrangements are known in the art.

Printer 10 preferably receives print data from a host machine 5 which may be a computer, facsimile machine, Internet terminal, camera, plotter or other device that is capable of propagating print data to printer 10.

Printhead 40 is preferably provided on a moveable carriage 41 that may move transversely along guide rods as is known. Transverse motion is indicated by two headed arrow A. It should be recognized, however, that printhead 40 could be stationary and, for example, formed as wide as a sheet (or section of a sheet) of print media, such as paper.

Printhead 40 preferably includes a substrate 42 of a semiconductive or other suitable material on/in which are formed a plurality of firing chambers 80 (shown in FIG. 2) each preferably with an associated ink expulsion point or nozzle 44. The nozzles may be grouped into primitives 45 which are subsets of nozzles in which only one nozzle (or less than all nozzles) is fired per firing interval. While FIG. 1 illustrates four nozzles per primitive, more of less than this number may be provided. The use of primitives may decrease power consumption and lead interconnects and may address fluidic concerns.

Referring to FIG. 2, a cross-sectional view of a representative firing chamber 80 for use in printhead 40 of FIG. 1 is shown. The term firing chamber refers generally to the collection of components that expel an ink drop. Suitable firing chambers are known in the art and include firing chambers having different components and configurations than shown in FIG. 2. Firing chamber 80 includes an orifice layer 81, in which nozzle 44 is formed, a barrier layer 82 that helps define ink well 83, a passivation layer (or like protection layer) 84 and an ink expulsion element 85 such as a resistor or mechanical actuator or the like. A firing signal is delivered to the expulsion element via conductive material 89. The above components are preferably formed on a semiconductive substrate 86.

The firing chamber of each nozzle preferably receives a firing signal and a nozzle select signal. Such configurations are known in the art.

Referring again to FIG. 1, nozzle select data is preferably delivered over any, some or all of lines 51-54 (discussed in more detail below). These lines are input to demultiplexing (demux) logic 60 and a single stream of print data is preferably output from the demux logic (over line 49) and delivered to the firing chambers. Which of lines 51-54 is used for signal transmission is preferably determined by a code loaded into configuration register 62. This code is transmitted over line(s) 56. A master clock signal is preferably delivered over line 57. Other printhead configuration data, as is known in the art, is preferably provided to the printhead over line(s) 59. This other data may include nozzle fire order, set point temperature, scan direction, etc. Logic for implementing and processing these other features is represented with reference numeral 63.

Configuration register 62 in conjunction with demux logic 60 and the master clock signal permits a selection of which of the print data lines to use in a given printhead implementation. For example, if EMI is not a significant consideration, it is conceivable that a single secure conductor such as a co-axial conductor (or other conductor) could be provided at line 51 and the demux logic setup to stream this serial data directly through to the nozzles (over line 49).

In another implementation, it is conceivable that to reduce EMI, print data is split, for example, into four components and each component is sent at 1 MHz (as opposed to sending an undivided print data signal at 4 MHz). The demux logic (using the clock signal and configuration register value as a guide) then assembles the four components into a stream at 4 MHz that is fed to the nozzles.

In this latter implementation, the print data signal is divided or generated in component parts in controller logic 25. Logic for generating print data in a divided or component format, termed generation logic 28, may include a multiplexer or serial to parallel shift register or other suitable logic. Controller 25 controls which of data lines 51-54 propagate data and sends an appropriate clock signal over line 57.

Referring to FIG. 3, a schematic diagram of demux and configuration logic in accordance with the present invention is shown. This logic preferably includes configuration register 62, next state logic 64, state register 65, zero detect logic 67 and shift register 70. Operation is generally as follows for an embodiment in which four possible data transfer lines are provided.

A value indicative of the number (e.g., 1-4) of transmission lines 51-54 to use in data transmission is propagated from controller logic 25 to configuration logic 62. These values may be 00,01,10,11 (or more, if more data lines are utilized). If, for example, all four lines are going to be used and the master clock signal is at 4 MHz, then data is preferably sent on each of lines 51-54 at 1 MHz. This results in a significant EMI reduction compared to sending the data on one line at 4 MHz.

If three of lines 51-54 are used, then signals are propagated on the utilized lines at 1.33 MHz, and if two of lines 51-54 are used, then signals are propagated on the utilized lines at 2 MHz.

The next state and state register logic are preferably configured to effectively form a count down counter. The configuration register is loaded with a value and the counter counts down from this value until zero is reached. Zero detect logic 67 recognizes this event and in response generates a latch signal that achieves a new load of data from lines 51-54 (or those of lines 51-54 that are activated) into shift register 70.

The master clock signal is also coupled to shift register 70. A bit is preferably shifted out with each occurrence of the master clock signal.

If, for example, a two (01) were loaded into configuration register 62, then locations 73 and 74 of shift register 70 would not be used. If 00 were loaded, then only location 71 would be used and the shift register latch and an output clock signal would occur at each master clock interval.

It should be recognized that the demux and configuration logic can be configured to latch on the positive and the negative transitions of the clock signal. This would permit, in the above example with 4 data lines, the use of a 2 MHz clock signal as opposed to a 4 MHz clock signal. This would reduce EMI caused by the clock signal. In addition, or alternatively, a phase locked loop 91 or the like (see FIG. 1) could be provided within the clock signal path to increase the frequency of the clock signal in the printhead. This permits propagation of a slower clock signal over line 57, and thus further reduces EMI.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A printing apparatus, comprising:
a printhead substrate;
a plurality of ink expulsion elements formed on said substrate;
a plurality of potential signal inputs formed on said substrate; and
logic coupled between said potential signal inputs and said plurality of ink expulsion elements that is configurable to receive and serialize data from one or more of said inputs.

2. The apparatus of claim 1, wherein said configurable receive logic sequentially combines data from the ones of said potential signal inputs that said configurable receive logic is configured to receive signals from to thereby create an output data stream.

3. The apparatus of claim 1, wherein said output data stream is propagated to said plurality of ink expulsion elements.

4. The apparatus of claim 3, wherein said configurable receive logic includes demultiplexing logic coupled to said plurality of potential signal inputs and configuration register logic coupled to said demultiplexing logic, and wherein said configuration register logic receives a value indicative of the number of said plurality of potential signal inputs to input data from and provides control signals to said demultiplexing logic to accept data from the indicated ones of said plurality of potential signal inputs.

5. The apparatus of claim 2, wherein said configurable receive logic includes parallel to serial shift register logic that latches data from said plurality of potential signal inputs on a number of master clock cycles indicated by a value received by said configurable receive logic and shifts out data on at least every master clock cycle.

6. The apparatus of claim 1, further comprising:
logic located other than on said printhead substrate that is capable of generating print data in separable components and propagating those components over separate conductors to at least two of said plurality of potential signal inputs.

7. The apparatus of claim 1, further comprising a clock signal input and logic coupled to said clock signal input that responds to the negative and positive transitions of a clock signal received at the clock signal input.

8. The apparatus of claim 1, further comprising a clock signal input and logic coupled to said clock signal input that creates a signal having a higher frequency than a frequency of a clock signal received at said clock signal input.

9. The apparatus of claim 1, further comprising at least one of the group of elements including:
a print media I/O unit;
an ink supply;
a power supply; and
a movable printhead carriage.

10. A printing apparatus, comprising:
a controller;
a printhead substrate coupled to said controller and having a plurality of potential signal inputs and a plurality of ink expulsion elements formed thereon;
configuration logic formed on said substrate and coupled to said plurality of potential signal inputs; and
logic in said controller that generates:
(1) a first signal indicative of the number of said plurality of potential signal inputs to which said controller is to propagate data to; and
(2) data in separable components equal in number to the number indicated by said first signal.

11. The apparatus of claim 10, wherein said configuration logic is coupled between said potential signal inputs and said plurality of ink expulsion elements and said configuration logic is configurable to receive and serialize data from one or more of said inputs.

12. The apparatus of claim 11, wherein said configurable receive logic includes demultiplexing logic coupled to said plurality of potential signal inputs and configuration register logic coupled to said demultiplexing logic, and wherein said configuration logic receives said first signal and provides control signals to said demultiplexing logic to accept data from the indicated ones of said plurality of potential signal inputs.

13. The apparatus of claim 11, wherein said configurable logic includes parallel to serial shift register logic that latches data from said plurality of potential signal inputs on a number of master clock cycles indicated by said first signal and shifts out data on at least every master clock cycle.

14. A method for a printing apparatus, comprising the steps of:
providing a printhead substrate having a plurality of ink expulsion elements and a plurality of potential signal inputs formed on said substrate;
providing processing logic coupled between said potential signal inputs and said plurality of ink expulsion elements that is configurable to receive and serialize data from one or more of said inputs; and
configuring said processing logic based on a received configuration signal to receive data from a given number of said plurality of potential signal inputs.

15. The method of claim 14, further comprising the steps of:
sequentially combining data from the ones of said potential signal inputs that said processing logic is configured to receive data from; and
creating an output data stream of said sequentially combined data.

16. The method of claim 15, further comprising the step of propagating said output data stream to said plurality of ink expulsion elements.

17. The method of claim 14, further comprising the steps of:
providing a clock signal input; and
creating a signal based on a clock signal received at said clock signal input that has a higher frequency than that of a clock signal received at said clock signal input.
